(19) United States
(12) Patent Application Publication
(10) Pub. No.: US 2014/0286488 A1
(43) Pub. Date: Sep. 25, 2014

(54) Determining a Division Remainder and Ascertaining Prime Number Candidates for a Cryptographic Application

(71) Applicant: GIESECKE & DEVRIENT GMBH, Munich (DE)

(72) Inventor: Jurgen Pulkus, Munich (DE)

(21) Appl. No.: 14/354,254

(22) PCT Filed: Oct. 25, 2012
(86) PCT No.: PCT/EP2012/004476

§ 371 Date: Apr. 25, 2014

(30) Foreign Application Priority Data
Oct. 28, 2011 (DE) 102011117219.3

(51) Int. Cl. H04L 9/14

(52) U.S. Cl. CPC H04L 9/14
USPC 380/28

(57) ABSTRACT

A device and/or computer program uses a method including determining the division remainder of a first value (b) modulo a second value (p′) and executing a first Montgomery multiplication with the first value (b) as one of the factors and the second value (p′) as a module. A correction factor is determined, and a second Montgomery multiplication is executed with the result of the first Montgomery multiplication as one of the factors and the correction factor as the other factor and the second value (p′) as a module. A method for ascertaining prime number candidates includes determining a base value (b) for a sieve, and several sieve iterations are executed, in which respectively one marking value (p′) is ascertained and multiples of the marking value (p′) in the sieve are marked as composite numbers.

The invention relates in general to the technical field of efficiently implementable cryptographic methods. More specifically, a first aspect of the invention relates to determining a division remainder, while a second aspect of the invention relates to ascertaining prime number candidates—these are values that represent with a certain probability prime numbers. The invention is particularly suitable for the use in a portable data carrier. Such a portable data carrier can be e.g. a chip card (smart card) in different designs or a chip module or a comparable limited-resource system.

Efficient methods for ascertaining prime numbers are required for many cryptographic applications. For example, for the key generation in the RSA method described in U.S. Pat. No. 4,405,829 two secret prime numbers must be established, the product thereof forming a part of the public key. The size of these prime numbers depends on the security requirements and normally amounts to several hundred to several thousands of bits. It is expected that the required size will still grow in the future.

Altogether, the prime number search is by far the most computationally intensive step in the RSA key generation. For security reasons it is often required that the key generation is executed by the data carrier itself. Depending on the type of the data carrier, this process may cause an expenditure of time during the production of the data carrier (e.g. the completion or initialization or personalization), which strongly varies and might possibly amount to several minutes. As production time is expensive, the time required for the key generation represents a considerable cost factor. It is therefore desirable to accelerate the key generation and thus to increase the achievable throughput of a production plant for portable data carriers.

An important step for reducing the production time is to employ an efficient method for the prime number search, which further fulfills some boundary conditions with respect to the generated prime numbers. Such methods have already been proposed and are known for example from the laid-open applications DE 10 2004 044 453 A1 and EP 1 564 649 A2.

In RSA methods also the encryption and decryption processes effected after the key generation are relatively computationally intensive. In particular for portable data carriers with their limited computing power there is therefore often used an implementation that employs the Chinese remainder theorem (CRT) for decryption and signature generation and is thus also referred to as RSA-CRT method. By employing the RSA-CRT method the computing expenditure required for decryption and signature generation is reduced by about the factor of 4.

For preparing the RSA-CRT method there are calculated, upon the determination of the private key, further values besides the two secret RAS prime factors and stored as parameters of the private key. For example the laid-open application WO 2004/032411 A1 contains more detailed information about this. Since the calculation of the further RSA-CRT key parameters likewise is normally executed during the production of the portable data carrier, it is desirable to also employ methods that are as efficient as possible therefor.

Many portable data carriers contain coprocessors which support certain calculation processes. In particular, there are known data carriers whose coprocessors support an operation known as Montgomery multiplication, which is described in the article “Modular multiplication without trial division” by Peter L. Montgomery, published in Mathematics of Computation, Vol. 44, no. 170, April 1985, pages 519-521. Montgomery coprocessors usually neither support the modular nor the non-modular “normal” multiplication with the bit-lengths required for cryptographic tasks. For other coprocessors may possibly apply that modular or non-modular multiplications are supported, but are executed less efficient than the Montgomery multiplication. Also division operations are not supported by many usual Montgomery coprocessors or not efficiently supported or not with the bit-lengths required for cryptographic tasks. It would be desirable to exploit the capabilities of coprocessors that are currently available or will come into the market in the future as well as possible.

Accordingly, it is the object of the invention to provide an efficient technology for determining a division remainder or for ascertaining prime number candidates.

According to the invention, this object is achieved in whole or in part by a method having the features of the claim 1 or of the claim 8, a computer program product according to claim 14, and a device, in particular a portable data carrier, according to claim 15. The dependent claims relate to optional features of some configurations of the invention.

A first aspect of the invention starts out from the basic consideration to carry out a Montgomery multiplication instead of an otherwise usual modular division for determining a division remainder. The error caused by the Montgomery multiplication is then compensated by a further Montgomery multiplication, a suitably determined correction factor serving as one of the factors of this further Montgomery multiplication. This method can be implemented on many usual hardware platforms far more efficiently than a modular division with a remainder.

In some configurations the first Montgomery multiplication is a Montgomery reduction, i.e. a multiplication with 1 as one of the two factors. Preferably, the two Montgomery multiplications are executed with different Montgomery coefficients.

In some embodiments the correction factor is calculated in a loop as a modular power of two, each loop iteration having a duplication of an intermediate result and a conditional subtraction. In other embodiments, however, the correction factor is calculated as a modular power with a positive and integer correction-factor exponent and the base ½. For this purpose again Montgomery operations can be used.

A second aspect of the invention starts out from the basic idea to ascertain prime number candidates in a sieve method. In so doing, starting out from a base value several sieve iterations are executed, in which respectively one marking value is determined and multiples of the marking value are marked in the sieve as composite numbers. Further, in each sieve iteration a division remainder of the base value modulo the marking value is determined with a remainder determination method, which is particularly efficiently implementable on usual hardware platforms, because it comprises at least one Montgomery operation.

In preferred embodiments the (at least one) marking value is a prime number. Advantageously, several prime numbers can be employed as marking values for a sieve iteration. The sieve may represent for example, starting out from the base value, only numbers of a predetermined step width. In some configurations, further prime number tests are executed, in order to ascertain probable prime numbers from the prime number candidates. In many configurations of the method according to the second aspect of the invention a remainder determination method according to the first aspect of the invention is employed.

The order of enumeration of the steps in the method claims should not be understood as a restriction of the scope of protection. Rather, there are also provided embodiments of the invention in which these steps are executed wholly or partly in a different order and/or wholly or partly interleaved and/or wholly or partly in parallel.

The computer program product of the invention has program commands, in order to implement the method of the invention. Such a computer program product can be a physical medium, e.g. a semiconductor memory or a disk or a CD-ROM. However, in some embodiments the computer program product can also be a non-physical medium, e.g. a signal conveyed via a computer network. In particular, the computer program product can contain program commands which are incorporated into the portable data carrier in the course of the production thereof.

The device according to the invention can in particular be a portable data carrier, e.g. a chip card or a chip module. Such a data carrier contains in a per se known manner at least one processor, several memories configured according to different technologies and various auxiliary component groups. In the wording of the present document the term “processor” shall comprise main processors as well as coprocessors.

In preferred developments, the computer program product and/or the device have features which correspond to the features mentioned in the present description and/or stated in the dependent method claims.

Further features, tasks and advantages of the invention can be found in the following description of various exemplary embodiments and alternative embodiments. Reference is made to the schematic drawing.

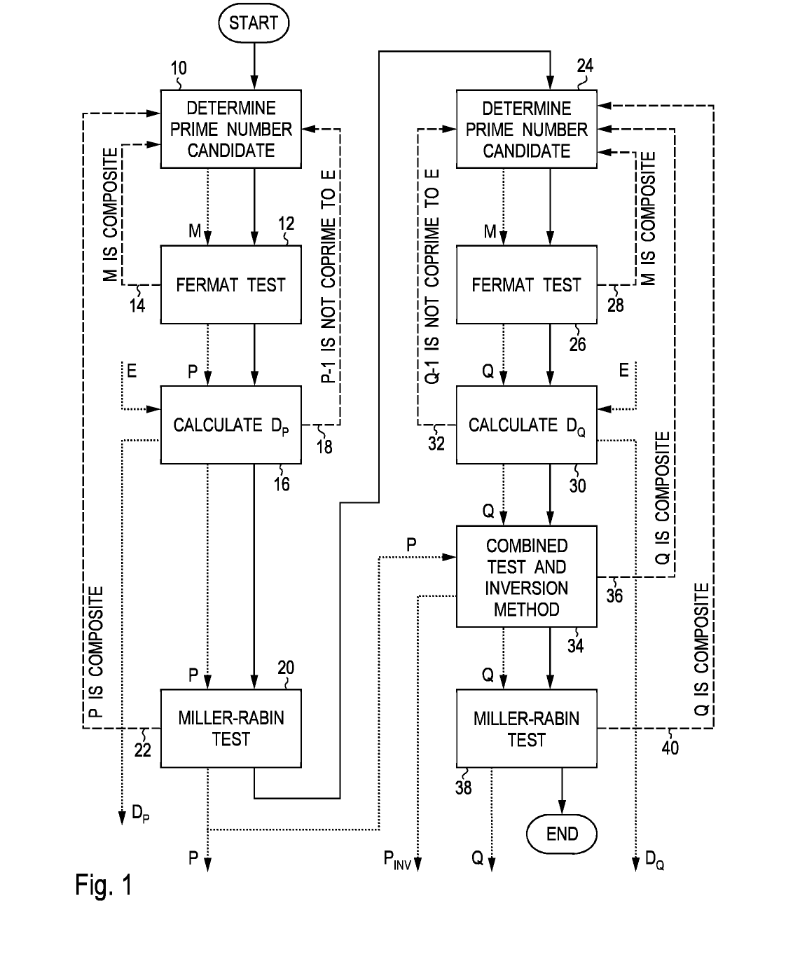

FIG. 1 shows a flow diagram of a method for the determination of two prime numbers as well as further parameters of an RSA-CRT key,

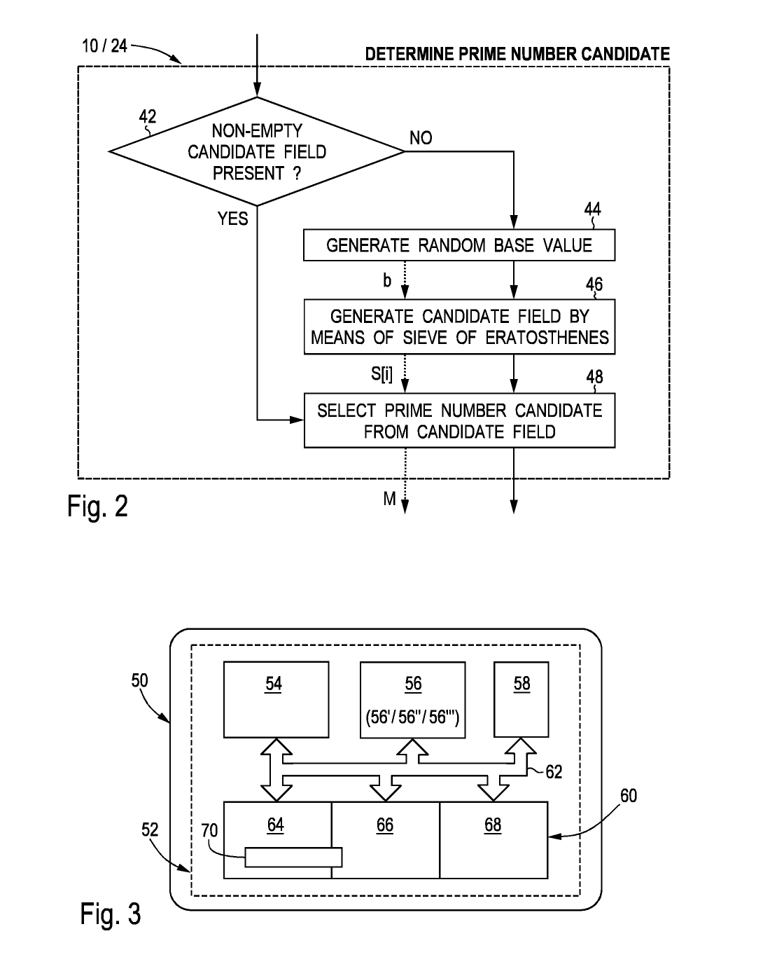

FIG. 2 shows a flow diagram of a method for the determination of a prime number candidate,

FIG. 3 shows a schematic representation of components of a portable data carrier which is suitable for the execution of the methods of FIG. 1 and FIG. 2,

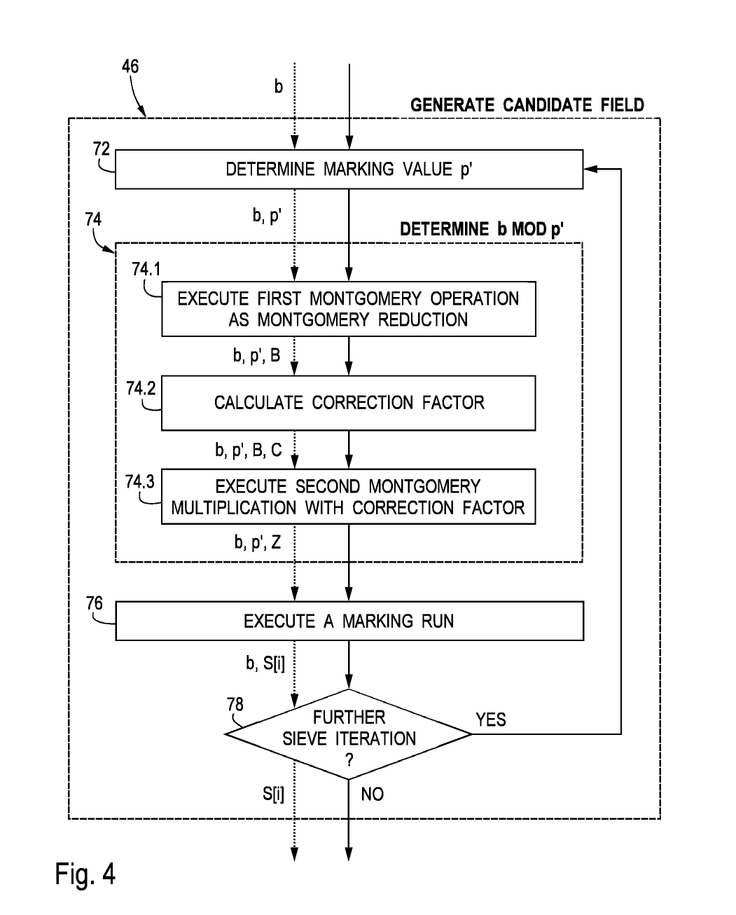

FIG. 4 shows a flow diagram of a method for generating a candidate field, and

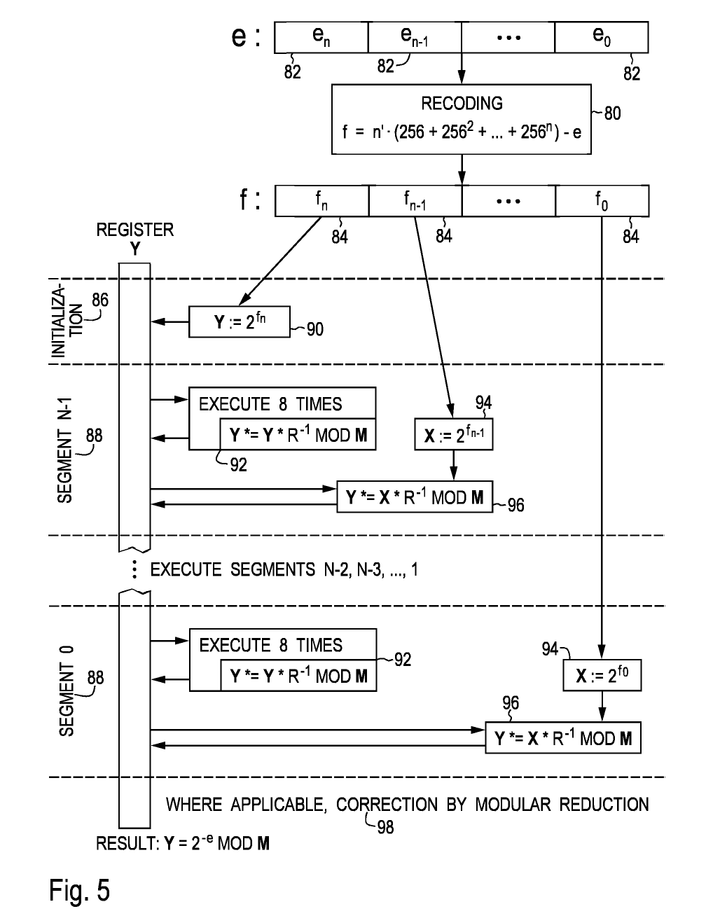

FIG. 5 shows an exemplary course of a method for the modular calculation of the power with the base ½ and a positive and integer exponent e employing Montgomery operations.

In the present document, the invention is described in particular in connection with the determination of one, several or all the parameters of an RSA-CRT key pair. But the invention is also usable for other application purposes, in particular for the determination of relatively large and random prime numbers, as they are required for various cryptographic methods.

In general, the parameters of an RSA-CRT key pair are derived from two secret prime numbers p and q as well as a public exponent e. Here, the public exponent e is a number coprime to the value (p−1) (q−1), which number can be randomly chosen or firmly specified. For example, in some exemplary embodiments the fourth Fermat prime number F₄=2¹⁶+1 is employed as a public exponent e. The public key contains the public exponent e and a public module N:=p·q. The private RSA-CRT key contains, beside the two prime numbers p and q, the modular inverse pᵢₙᵥ:=p⁻¹ mod q as well as the two CRT exponents dₚ and d_{q}, which are defined by dₚ:=e⁻¹ mod (p−1) and d_{q}:=e⁻¹ mod (q−1).

The method according to FIG. 1 shows the calculation of all the parameters of a secret RSA-CRT key with specified public exponent e. The method consists of two parts which are represented in a left and right column of FIG. 1. The first part (steps 10, 12, 16 and 20) comprises the determination of the one prime number p and of the key parameter dₚ connected therewith, while the second part (steps 24, 26, 30, 34 and 38) relates to the determination of the other prime number q and of the key parameters d_{q} and pᵢₙᵥ.

It is to be understood that in alternative embodiments the method can be modified in such a way that only some of the above-stated parameters are calculated. For this purpose, for example method steps can be omitted or shortened, when some key parameters are calculated otherwise or not needed. It can in particular be provided to execute only one of the two method parts shown in FIG. 1 (i.e. either only the steps 10, 12, 16 and 20 or only the steps 24, 26, 30, 34 and 38), when only one single prime number needs to be determined.

In FIG. 1 and the further drawing figures, the continuous arrows show the regular program flow, and the dashed arrows show alternative program sequences, which are executed under certain conditions—in particular when a prime number candidate or a prospective prime number proves to be composite. The dotted arrows illustrate the data flow.

The course represented in FIG. 1 starts in step 10 with the generation of a first prime number candidate m which fulfills certain boundary conditions (in particular the boundary condition m≡3 mod 4). In the exemplary embodiments described herein, upon the determination of each prime number candidate m a pre-selection is made, which ensures that the prime number candidate m is not divisible already by a small prime number (e.g. 2, 3, 5, 7, . . . ). A suitable determination method with pre-selection is shown in FIG. 2 and is hereinafter described in more detail.

In step 12 the prime number candidate m is subjected to a Fermat test. The Fermat test is a probabilistic prime number test, which recognizes a composite number as such with a high probability, while a prime number is never falsely regarded as a composite number. The Fermat test is based on Fermat's little theorem, which says, that for each prime number p and each natural number a there applies the relation d^{p}≡a mod p. The inversion does not necessarily apply, but counter-examples are so rare that a prime number candidate m which passes the Fermat test is, with a probability bordering on certainty, a prime number.

If the prime number candidate m is recognized as a composite number in the Fermat test in step 12, a return 14 to step 10 is effected, in which a new prime number candidate is determined. Otherwise, the method is continued, the prime number candidate m being regarded as a prospective prime number p.

In step 16 the CRT exponent dₚ, which is defined by virtue of dₚ:=e mod (p−1), is calculated. For this purpose, a per se known inversion method is employed. The CRT exponent dₚ as the modular inverse of the public exponent e exists exactly when e and p−1 are coprime, i.e. when gcd(p−1, e)=1 applies. If this is not the case, a return 18 to the beginning of the method is effected. Otherwise, the CRT exponent dₚ is determined in step 16 and the method is then continued in step 20 with a Miller-Rabin test of the prospective prime number p. The Miller-Rabin test is known as such from the article “Probabilistic algorithms for testing primality” by Michael O. Rabin, published in Journal of Number Theory 12, 1980, pages 128-138. In each test round of the Miller-Rabin test a composite number is recognized as such with a certain probability, while a prime number is never falsely regarded as a composite number. The error probability of the Miller-Rabin test depends on the number of test rounds and can be kept arbitrarily low by a sufficient number of test rounds being executed.

Due to the high accuracy of the Fermat test in step 12, which has already been mentioned above, the probability that the prospective prime number p is recognized as a composite number in the Miller-Rabin test in step 20 is negligible. The probability that the calculation of the CRT exponent dₚ in step 16 fails due to gcd(p−1, e)≠1 and the return 18 must be executed, however, is by orders of magnitude higher. It is thus more efficient to execute the step 16 before step 20, because this avoids unnecessary Miller-Rabin tests. Nevertheless, the invention also comprises exemplary embodiments, in which the CRT exponent dₚ is only calculated after the Miller-Rabin test or at a different time. Further, in alternative embodiments it can be provided to execute the calculation of the CRT exponent dₚ separated from the method for the ascertainment of prime numbers described herein; the step 16 can then be omitted.

The Miller-Rabin test in step 20 is executed so that a desired maximum error probability, which may amount to for example 2⁻¹⁰⁰, can be mathematically proven. In the Miller-Rabin test there are executed several test rounds, the number of which depends on this error probability. A test round for the prospective prime number p consists in a random number being raised to the ((p−1)/2)-th power modulo p, and it being checked whether the result is ±1 modulo p. Here, the boundary condition p≡3 mod 4 is assumed.

In the highly improbable case that the prospective prime number p is recognized as a composite number in one of the test rounds of the Miller-Rabin test in step 20, a return 22 to the beginning of the method is effected. Otherwise, the prime number p is output as one of the results of the method described herein.

The second method part, which is shown in the right column of FIG. 1, is, except for step 34, a repetition of the first method part according to the left column of FIG. 1, the second prime number q being calculated. Reference is hence largely made to the explanations above.

The steps 24, 26 and 30 are analogous to the steps 10,12 and 16. When the prime number candidate m selected in step 24 turns out to be composite upon the Fermat test in step 26, a return 28 is executed to the selection of a new prime number candidate in step 24. Otherwise, the CRT exponent d_{q}:=e⁻¹ mod (q−1) is calculated in step 30. A return 32 to the step 24 is effected, if e and q−1 are not coprime. Otherwise, the method is continued with the prospective prime number q. Similar to the first method part, modifications are provided here too, in which the CRT exponent d_{q} is calculated at a different time in connection with the method described herein or separated therefrom.

In step 34, a combined test and inversion method is executed, in which a first test round of a Miller-Rabin test for the prospective prime number q is coupled with the calculation of the inverse pᵢₙᵥ:=p⁻¹ mod q. Because q is a prime number, the inverse pᵢₙᵥ can be determined by virtue of Fermat's little theorem as pᵢₙᵥ=p⁻¹=p^{q-2} mod q. Because p is a random number, upon this calculation there can immediately be executed with little additional effort a first Miller-Rabin test round for the prospective prime number q, it being checked whether the ((q−1)/2)-th power of p modulo q is equal ±1.

In step 34, a return 36 to step 24 is effected, if the prospective prime number q does not pass the first Miller-Rabin test round. Otherwise, the further still required test rounds of the Miller-Rabin test are executed in step 38. If one of these test rounds fails, then a return 40 to step 24 is effected for the selection of a new prime number candidate. Otherwise, the second prime number q is known and the method ends.

In some embodiments, the method shown in FIG. 1 is modified to that effect that no combined test and inversion method is provided. For example, instead of step 36 there can be executed an additional round of the Miller-Rabin test in step 38. The calculation of the inverse pᵢₙᵥ can then be executed as a separate step—as a part of the method described here or separated therefrom—, if such a calculation is required at all. For example, in RSA-CRT calculations the inverse pᵢₙᵥ merely serves for increasing the efficiency. In RSA calculations without the use of the Chinese remainder theorem the inverse pᵢₙᵥ is not needed.

FIG. 2 illustrates the determination of a prime number candidate m, as it is executed in the steps 10 and 24 of FIG. 1. In the exemplary embodiments described herein, in so doing a candidate field is employed which provides several prime number candidates m. The candidate field can be, for example, a packed bitfield (bit array) S, whose bits S[i] indicate, whether or not a number, which has a shifting relative to a base value b, which shifting is dependent on the bit position i, is a prime number candidate m.

In the method according to FIG. 2, in test 42 it is first checked whether a suitable and non-empty candidate field is present. If this is not the case, in step 44 a random base value b is generated, which fulfills the conditions

b≡3 mod 4.

In step 46, then the candidate field is generated. In the present exemplary embodiment, as a data structure for the candidate field a bitfield S is employed, whose bit positions i respectively correspond to a shifting of SWi relative to the base value b (with SW as the step width). Each bit S[i] of the completed candidate field thus indicates, whether or not the number b+SWi can be employed as a prime number candidate m.

For generating the candidate field in step 46, first all bits S[i] are initialized to a first value—e.g. the value “1”. Then, according to the principle of the sieve of Eratosthenes, those bits S[i] are changed to a second value—e.g. the value “0”—, which correspond to a number b+SWi divisible by a small prime number. The size of the candidate field and the number of sieve iterations are selected such—in dependence on the available memory space—that the average runtime of the overall method is minimized. This is an optimization task the solution of which depends on the relative effort for the pre-selection compared with the effort for a failed Fermat test. For RSA keys with 2048 bit there can be executed, for example, several thousands of sieve iterations, then about 40 Fermat tests being necessary for the determination of one of the prime numbers p and q.

In step 48, finally, a prime number candidate m is selected from the filled candidate field. This selection can be effected for example randomly or according to a specified order. In case of further calls of the method shown in FIG. 2, step 48 is executed directly after the test 42, and further prime number candidates m are selected from the once created candidate field until the field is empty or a specified minimum filling quantity is undershot.

In some embodiments the method shown in FIG. 1 and FIG. 2 is executed by at least one processor of a portable data carrier. FIG. 3 shows such a data carrier 50 which is configured for example as a chip card or chip module. The data carrier 50 has a microcontroller 52 in which are integrated in a per se known manner a main processor 54, a coprocessor 56, a communication interface 58 and a memory component group 60 on a single semiconductor chip and interconnected via a bus 62.

The memory component group 60 has several memory fields configured in different technologies, which comprise, for example, a read-only memory 64 (mask-programmed ROM), a non-volatile overwritable memory 66 (EEPROM or flash memory) and a working memory 68 (RAM). The methods described herein are implemented in the form of program commands 70 which are contained in the read-only memory 64 and partly also in the non-volatile overwritable memory 66.

The coprocessor 56 of the data carrier 50 is designed for the efficient execution of various cryptographic operations. For the exemplary embodiments described herein it is in particular relevant that the coprocessor 56 supports the Montgomery multiplication with bit-lengths as they are required for cryptographic applications. In some configurations, the coprocessor 56 does not support a “normal” modular multiplication, so that such multiplications must be executed with considerably higher effort by the main processor 54.

For natural numbers x, y and an odd natural number m with x, y<m as well as a power of two R, referred to as Montgomery coefficient, with R>m, the Montgomery product of x and y modulo m with regard to R is in general defined as follows:

x*_{m,R}y:=x·y·R⁻¹ mod m

In general, in the present document there is employed, when stating a modulo relation of the form “a=z mod m” the equality sign “=” or the definition sign“:=”, in order to express that a is the uniquely defined element from (z+ [symbol] )∩[0, . . . , m[, for which the modulo relation applies. The notation

“a≡z mod m”, however, merely expresses that the equivalence modulo m applies.

When the Montgomery coefficient R results from the context, in the present document there is often also employed the abbreviated notation x*ₘy instead of the detailed notation x*_{m,R}y for the Montgomery product.

Although the above-defined Montgomery multiplication is a modular operation, it can be implemented without division, as this is per se well known and is described e.g. in the article “Modular multiplication without trial division” stated at the outset. For a Montgomery multiplication there are required two non-modular multiplications, an auxiliary value previously calculated in dependence on m and R, some additions, and a terminating conditional subtraction from m. These calculations can be efficiently executed by the coprocessor 56.

With currently commercially available microcontrollers 52 there are known configurations of coprocessors 56′, 56″, 56′″ which execute not exactly the Montgomery multiplication defined above but modifications thereof. The reason for these modifications primarily lies in the fact that the decision, whether the terminating conditional subtraction of the Montgomery multiplication is to be executed, can be optimized in different ways. In general, upon the calculation of the Montgomery multiplication the modified coprocessors 56′, 56″, 56′″ deliver a result, which potentially differs from the above-defined result by a small multiple of the module m. Further, with the modified coprocessors 56′, 56″, 56′″ the permissible range of values for the factors x and y is extended such that a calculated result always represents in turn a permissible input value as a factor of the Montgomery multiplication.

More precisely, a first modified coprocessor 56′ calculates a first modified Montgomery product x*′ₘy, which is defined as follows:

x*′ₘy:=(x·y·R⁻¹ mod m)+k·m

Here, R=2ⁿ for certain register sizes n which are multiples of 16. The range of values for the factors x and y is extended to [0, . . . , R−1], and k is a natural number which is so small so that x*′ₘy<R applies.

A second modified coprocessor 56″, however, calculates a second modified Montgomery product x*″ₘy, which is defined as follows:

x*″ₘy:=(x·y·2^{-n′} mod m)−ε·m

The factors x and y are here integers in the range of −m≦x, y<m. There further applies εε{0, 1}, and the exponent n′ has the value n′=n+16p for a precision p=1, 2 or 4, a block size c with 160≦c≦512, which is a multiple of 32, and a register size n=c·p. For the module m there applies m<2ⁿ, and the value R is defined as R:=2^{n′}.

A third modified coprocessor 56′″ finally calculates a third modified Montgomery product x*′″ₘy, which is defined as follows:

x*′″ₘy:=(x·y·2^{-t·c} mod m)+ε·m

The factors x and y are here natural numbers with x<2^{t·c} and y<2·m. There further applies εε{0, 1}. The block size c is fixed and amounts to c=128. The register size for the factor x amounts to t·c. The register size for the other variables is designated by n and amounts to a multiple of the block size c. When there applies n=t·c, then the factor x only needs to satisfy the condition x<max {2·m, 2ⁿ} instead of the condition x<2^{t·c}.

In the present document, the Montgomery product of two factors x and y with regard to the module m is generally designated by x*ₘy, when it does not play a role or is indicated through context whether it is exactly the Montgomery product x*ₘy of the coprocessor 56 according to the originally stated definition or one of the three modified Montgomery products x*′ₘy or

x*″ₘy or x*′″ₘy of one of the coprocessors 56′, 56″, 56′″.

In general, each “normal” modular multiplication x·y=z mod m can be replaced by a Montgomery multiplication x′*y′=z′, when the input values x, y first are converted, by means of respectively one Montgomery transformation, into their corresponding Montgomery representations x′,y′ and then the result value is inversely transformed from its Montgomery representation x′ into the value x. The Montgomery transformation can be effected for example by the calculation x′:=x·R mod m. Upon the inverse transformation, the result z:=z′·R⁻¹ mod m can be efficiently determined by a Montgomery multiplication with the factor 1, i.e. by the calculation z:=z′*ₘ1.

Because of the required forward and inverse transformations it is normally not efficient to replace one single modular multiplication by a Montgomery multiplication. But when several multiplications are to be executed successively—as this is the case for example with a modular exponentiation—, then these multiplications can be carried out completely in the Montgomery number range. Then only one single forward transformation at the beginning of the calculation sequence and one single inverse transformation at the end of the calculation sequence is necessary.

According to the just-described principle, in the method shown in FIG. 1 and FIG. 2 some or all modular multiplications can be implemented as Montgomery multiplications. It is to be understood, that calculation segments which are effected in the Montgomery number range are to be combined here, if possible, in order to reduce the number of required forward and inverse transformations. Additions and subtractions can be executed in the “normal” number range and in the Montgomery number range without difference.

The employment of Montgomery multiplications is particularly advantageous, when the data carrier 50 has a coprocessor 56, 56′, 56″, 56′″ which supports the Montgomery multiplication but not the normal modular multiplication. Even when the coprocessor 56, 56′, 56″, 56′″ supports both multiplication types, the Montgomery multiplication is often executed more efficient. Depending on the number of required transformations—in particular on the forward transformations which are more elaborate in comparison to the inverse transformations—there results a considerable saving even when a Montgomery multiplication should be executed only slightly more efficient than a normal modular multiplication.

In the exemplary embodiments described here, the method shown in FIG. 1 and FIG. 2 is optimized in particular with regard to the generation of the candidate field in step 46 (FIG. 2). As already mentioned, the solution described here starts out from the basic idea to ascertain prime number candidates by a sieve process according to the principle of the sieve of Eratosthenes. In the exemplary embodiments described here, the sieve starts at a random base value b, however, which already has approximately the order of magnitude of the prime number to be ascertained, and it contains entries which respectively correspond to the values b+SWi (with step width SW).

Further, in the exemplary embodiments described here there is carried out only a specified number of sieve iterations with respectively one small prime number p′ or a product p′ of several prime numbers as marking values r, r′. After these sieve iterations, the values remaining in the sieve, which are designated as prime number candidates m, represent only with a certain probability a prime number. As already mentioned, the number of sieve iterations is established for the overall method in the course of an optimization of the computing time. For example, several thousands of sieve iterations can be carried out, and a number that remains in the sieve is a prime number with a probability of approximately 2.5%.

Since the sieve does not start at zero, for each sieve iteration there must be determined the remainder of the base value b modulo the marking value p′, which serves as a base for the sieve iteration. From this remainder there is then ascertained the first composite number b+SWk to be deleted from the sieve, and starting out from this number b+SWk the further multiples b+SWk+SWp′, b+SWk+2·SWp′, b+SWk+3·SWp′, . . . are deleted from the sieve.

The exemplary embodiments described here relate in particular to the efficient determination of the just-stated remainder z:=b mod p′. It is the basic idea of these embodiments that for the determination of the remainder z not a “normal” modular division with remainder is employed, but a Montgomery operation with at least one further correction step. This Montgomery operation can be in particular a Montgomery reduction with p′ as a module. A Montgomery reduction is understood to be here a Montgomery multiplication in which one of the factors has the value 1.

In a first exemplary embodiment it is assumed that the marking value p′—e.g. a prime number—, which is used for the loop iteration, has a width of d bit (e.g. 16 bit), and that the base b has a width of n·d bit. Then the Montgomery reduction b*_{p′·2}^{d·n} 1 is executed which yields by definition the value b·1·2^{--d·n} mod p′. For the desired result of b mod p′ there has thus arisen an “error” by the factor 2^{-d·n} mod p′, which is compensated by one or several correction steps.

The required correction can be executed in arbitrary fashion. In the present exemplary embodiment it is provided, however, to again carry out a Montgomery operation for this, namely a Montgomery multiplication modulo p′ with regard to the Montgomery coefficient 2^{d}.

By this Montgomery multiplication there is caused a further deviation from the desired result, namely by the additional factor 2^{-d} mod p′. It is thus advantageous to take into account this additional factor already upon the correction, so that this correction is carried out as a Montgomery multiplication of the result of the Montgomery reduction with the factor 2^{d}·2^{d·n} mod p′=2^{d·(n+1)} mod p,

Altogether, the remainder b mod p′ is thus calculated as follows:

(b*_{p′,2}^{d·n}1)*_{p′,2}^{d}2^{d·(n+1)mod p′}

In so doing, the correction factor 2^{d·(n+1) mod p′} can be determined in a particularly simple method by a loop. Starting out from a start value 1, in this loop in each loop iteration the respectively current value is duplicated, and p′ is subtracted, if the result amounts to at least p′.

The following representation of the just-described method reflects in more detail an exemplary calculation course. The representation relates to the more general task to determine for a d-bits-wide value X in a register X and a (n·d)-bit-wide value Yin a register Y the remainder Z with Z:=Y mod X in a register Z. Obviously, the method can be easily employed for the ascertainment of the remainder z:=b mod p′ which is required here, by the marking value p′ being registered in the register X and the base b in the register Y. The method can also be employed in connection with other cryptographic calculations, however, in which a remainder must be determined:

Method A
Input values: d-bit-wide value (e.g. prime number p′) in the register X n·d-bit-wide value (e.g. base b) in the register Y
Register: B, C, X, Y, Z
Output value: Remainder Y mod X in register Z

Method course:
SET B=Y*2^{-d·n} mod X (A.1)
SET C=2^{·(n+1)} mod X (A.2)
SET Z=B*C*2^{-d} mod X (A.3)

The process in line (A.1) is executed by a Montgomery multiplication Y*_{X, 2}^{d·n}1, whose factors Y and 1 have different lengths. The process in line (A.3) is executed by a Montgomery multiplication B*_{X, 2}^{d} C with the factors B and C.

The general method A can be optimized, however, as represented in the following for the modified methods A′ and A″.

If the marking value is a prime number p′, the first Montgomery multiplication can be omitted.

Method A′
Input values: d-bit-wide value (e.g. prime number p′) in the register X n·d-bit-wide value (e.g. base b) in the register Y
Register: C, X, Y, Z
Output value: Remainder Y mod X in register Z
Method course:
   SET C=2^{d·n} mod X (A′.2)
   SET Z=Y*C*2^{-d·n} mod X (A′.3)

The process in line (A′.2) consists in setting register C to the correction value dependent on X. The process in line (A′.3) is executed by a Montgomery multiplication Y*_{X, 2}^{d·n} C, whose factors Y and C have different lengths.

If, however, a marking run is carried out with two (or more) marking values r and r′ simultaneously, the following configuration is advantageous.
Method A″ (exemplary for two prime numbers r and r′)
Input values: d-bit-wide value (e.g. product p′=r*r′ of prime numbers r and r′) in the register X
   n·d-bit-wide value (e.g. base b) in the register Y
Register: B, C, C′, X, X′, Y, Z, Z′
Output values: Remainder Y mod r in register Z
   Remainder Y mod r′ in register Z′
Method course:
   SETB=Y*2^{-d·n} mod X (A″.1)
   SET X=r (A″.a)
   SET C=2^{d·(n+1)}mod X (A″.2.a)
   SET Z=B*C*2^{-d} mod X (A″.3.a)
   SET X′=r′ (A″.b)
   SET C′=2^{d·(n+1)} mod X′ (A″.2.b)
   SET Z′=B*C′*2^{-d} mod X′ (A″.3.b)

The process in line (A″.1) is executed, like in the method A, by a Montgomery multiplication Y*_{X, 2}^{d·n}1, whose factors Y and 1 have different lengths. The process in line (A″.3a) and (A″.3b) is executed, like in the method A, by a Montgomery multiplication B*_{X, 2}^{d} C with the factors B and C.

For each marking value there is accordingly calculated the remainder value (b MOD r and b MOD r′), so that both marking values can be deleted from the sieve in one marking run.

The modular exponentiation in line (A.2), (A′.2) and (A″.2a and 2b) can be implemented, as already mentioned above, by a loop carrying out in d (n+1) loop iterations respectively one duplication (bitwise shift by one bit position to the left) and a conditional subtraction. In the pseudocode notation employed here, for example line (A.2) can thus be replaced by the following lines (A.2.1)-(A.2.5):
SET C=1 (A.2.1)
EXECUTE d·(n+1) TIMES (A.2.2)
   SHIFT C BY 1 BIT TO THE LEFT (A.2.3)
   IF C≧X THEN SET C=C−X (A.2.4)
END (A.2.5)

By the exemplary embodiments described here replacing a division having a long dividend by at least one Montgomery multiplication, they are particularly suitable for an employment in a data carrier 50 which does not support long divisions or less efficient than Montgomery multiplications. This constellation is given in many usual data carriers 50, because an efficient hardware support for long divisions would require a high effort.

For example the data carrier 50 having the coprocessor 56″ does not support any division operations at all, while the coprocessor 56′″ provides a division function, but it takes approximately 128 times longer to execute a division than to execute a Montgomery multiplication of the same bit-length. With the data carrier 50 having the coprocessor 50′ it can even be advantageous, however, to not employ the techniques described here, because on the main processor 54 of this data carrier 50 there can be implemented a fast reminder-value calculation modulo a small prime number.

It is to be understood, that the method steps described herein can be distributed to different extents to the main processor 54 and the coprocessor 56, 56′, 56″, 56′″ of the data carrier 50. For example, in case of the data carrier 50 having the coprocessor 56″ it is advantageous to have all the method steps of the lines (A.1)-(A.3) carried out by the main processor 54, because the coprocessor 56″ works not very efficiently for Montgomery multiplications having differently long factors and is, moreover, limited to factors whose absolute value is smaller than the module p′. In case of the data carrier 50 having the coprocessor 56′″, the main processor 54, however, is relatively slow and does not support divisions, while the coprocessor 56′″ is very well suited for the method described here. It is thus advantageous to use this coprocessor 56′″ for all the method steps of the lines (A.1)-(A.3).

FIG. 4 shows by way of example the individual method steps of generating the candidate field in step 46 (FIG. 2). As an input value there is already present the base value b, which was ascertained in the preceding step 44. The method comprises a predetermined number of sieve iterations, in which respectively the steps 72-78 are executed.

At the beginning of each sieve iteration, in step 72 there is determined a marking value p′, whose multiples are to be marked in the sieve as composite numbers. In the hitherto described configurations, the marking value p′ has been a small prime number with e.g. a maximum length of 16 bits, while in other embodiments composite numbers—for example products of two or more prime numbers r, r″—can be employed as product p′=r*r′ for the prime numbers r and r′ as marking values.

In step 74 there is then ascertained the remainder of the base value b modulo the marking value p′. For this purpose, there is executed e.g. the already described method A or one of the modifications to be represented in the following. Step 74 according to FIG. 4 comprises three partial steps 74.1, 74.2 and 74.3. In the first partial step 74.1, which corresponds to line (A.1) of method A, the Montgomery reduction Y*_{X, 2}^{d·n} 1 is executed. The second partial step 74.2 corresponds to the line (A.2) or to the lines (A.2.1)-(A.2.5). Here, the correction factor C is calculated. In the third partial step 74.3, which corresponds to line (A.3) of method A, the required correction of the result of the Montgomery reduction of partial step 74.1 is executed by means of the Montgomery multiplication B*_{X, 2}^{d} C.

On the basis of the remainder b mod p′ there is then executed in step 76 a marking run. For this purpose, first there is ascertained the first bit S[k] in the bitfield S, whose associated value b+SW·k corresponds to a multiple of the marking value p′, i.e. to a composite number. This bit S[k] is marked accordingly, i.e. is set e.g. to the value “0”. Starting out from this k-th bit, there are then successively set the further bits at intervals of p′—i.e. the bits S[k+p′], S[k+2·p′], S[k+3·p′], . . . —respectively to the value which stands for composite numbers. These bits correspond to the values b+SWk+SWp′, b+SWk+2·SWp′, b+SWk+3·SWp′, and so on. Multiples of p′ lying in between do not need to be taken into consideration, because these multiples are not represented in the bitfield S.

As in method A′ already indicated, the Montgomery reduction in step 74.1 can be omitted, when the marking value is a prime number.

If, however,—as indicated in method A″—p′ is a product of (two or more) prime numbers, there is carried out a marking run for each of these prime numbers as a marking value. After a step 74.1 there follow the steps 74.2 and 74.3 for each of the (two) marking values r, r′. Starting out from the remainder (b mod r), which is determined for each marking value separately, also step 76 can be effected for each marking value.

After the end of the marking run of step 76, in step 78 it is checked whether a further sieve iteration is to be effected. If this is the case, a return to step 72 is effected. Otherwise, the generation of the candidate field is completed, and the method is continued with step 48 (FIG. 2).

In the hitherto described exemplary embodiments the correction factor was determined in step 74.2—corresponding to line (A.2) or lines (A.2.1)-(A.2.5)—by a modular calculation of the power with the base 2. The inventor has recognized, that on the hardware platforms treated herein a considerable increase of speed is possible, when a power of ½ instead of a power of two is calculated; suitable methods employing Montgomery multiplications are described in detail below. At first it is stated, however, how the correction factor C in the register C, which is stated in line (A.2) by C=2^{d·(n+1)} mod X, can be expressed as a power of ½.

At first it is to be noted that the factorization of the module X is known, because X is e.g. a prime number p′ or—in alternative embodiments—a product of prime numbers. Thus also the value of the Euler's totient function

φ(X) is known, because e.g. φ(p′)=p′−1 and φ(p₀·p₁)=(p₀−1)·(p₁−1) for prime numbers p₀ and p₁. Further, for all a which are coprime to X there applies α^{φ(X)}=1 mod X. Therefore, 2^{d·(n+1)} mod X=2^{-(k·φ(X)-d·(n+1))} mod X applies to a suitably selected k. Then the calculation C=2^{d·(n+1)} mod X n line (A.2) can be replaced by C=(½)^{k·φ(X)-d·(n+1)} mod X.

In the following there are described methods for the efficient determination of a positive power of ½ employing Montgomery operations, as they can be used for the just-mentioned calculation C=(½)^{k·φ(X)-d·(n+1)} mod X. For better comprehension, however, first a comparison method (“method 1”) is represented, which employs “normal” modular multiplications

a*_{M}b:=a·b mod M to calculate a power of two.

The comparison method 1 starts out from the per se known square-and-multiply-technique, in which there is effected for each bit of the exponent a squaring of an intermediate result and—in dependence on the value of the exponent bit—further a multiplication of the intermediate result with the base to be exponentiated. This square-and-multiply-technique, however, is potentially susceptible to side channel attacks, when by measuring the current consumption or other parameters there can be detected, whether or not upon the processing of a bit of the exponent the intermediate result is duplicated—i.e. is shifted to the left. Upon the comparison method 1 there is thus employed a modified technique, which could be referred to as “square-eight times-and-multiply-once-technique”.

In the “square-eight times-and-multiply-once-technique” respectively eight squarings are executed, but the pertinent potential multiplications are combined to respectively one single multiplication. The exponent bits for the deferred multiplications are respectively collected in a byte eᵢ, and the multiplication carried out is then effected with the factor 2^{e}^{ₜ}. Altogether, this method can be described with the following pseudocode notation:

Method 1
Input values: Exponent e=e₀+e₁·256+ . . . +eₙ·256ⁿ
   module in the register M
Register: M, X, Y
Output value: Power 2^{e} mod M in register Y
Method course:
   SET Y=2^{e}^{ₙ}
   FOR i=n−1 COUNTING DOWN TO 0 (1.2)
      EXECUTE 8 TIMES (1.3)
         SET Y*=Y mod M (1.4)
      END (1.5)
      SET X=2^{e}^{ᵢ} (1.6)
      SET Y*=X mod M (1.7)
   END (1.8)

In the pseudo notation above, the notation A*=B mod M means that the content of the register A is replaced by A·B mod M. The registers M, X and Y respectively have a size of at least 256 bits. The values eᵢ represent for 0≦i≦n the “digits” of the exponent e in a place value system with the base 256; thus 0≦eᵢ≦255 applies.

In line (1.1) there is effected the initialization of the register Y. For each byte of the exponent e a loop iteration is then executed, which respectively comprises the lines (1.3)-(1.7). In so doing, in the lines (1.3) and (1.4) the content of the register Y is squared eight times. In the lines (1.6) and (1.7) there is effected a multiplication of the intermediate result in the register Y with the factor 2^{e}^{ᵢ}. The calculations of the power in the lines (1.1) and (1.6) can be executed efficiently by e.g. for the calculation of A=2^{e}^{ₖ} first the register A being set to zero, and then the (k+1)-th bit—calculated from the lowest-order bit—being inverted to a “1”.

The comparison method 1 above is secure against side channel attacks, if multiplications with different powers of two cannot be distinguished by an attacker.

The inventor has recognized, that the comparison method 1 just described can be developed such that it employs Montgomery multiplications and is thus efficiently executable on data carriers 50 having suitable coprocessors 56, 56′, 56″, 56′″. Surprisingly, this is possible with relatively few modifications of the method course. In particular, in the developed method, which is referred to as “method 2” in the following, a negative power of two is calculated as a result, i.e. 2^{-e}=(½)^{e} instead of the value 2^{e} calculated in the method 1. Further, in method 2 there is provided an additional step, in which the exponent e is suitably recoded, in order to compensate the employment of the Montgomery operations instead of the “normal” modular multiplications and squarings in method 1.

Like in the comparison method 1, in method 2 there are employed two registers X and Y as well as a constant third register M for the module m. The register Y has the same size as M, while the register X may be smaller, where applicable. All three registers have at least 256 bits, and the module m amounts to at least 2²⁵⁵.

The method 2 is employable for all the above-stated coprocessors 56, 56′, 56″, 56′″. This universality is achieved in that the method employs only two generic Montgomery commands, which are available on all usual platforms. These commands are, firstly, the Montgomery squaring of the register Y and, secondly, the Montgomery multiplication of the registers X and Y. Upon the Montgomery squaring the value of the register Y is replaced by Y*_{m,R}Y. This Montgomery squaring is expressed in the following by the pseudocode command “SET Y*=Y*R⁻¹ mod M”. The Montgomery multiplication, upon which the value of the register Y is replaced by X*_{m,R}Y, is expressed in the following by the pseudocode command “SET Y*=X*R⁻¹ mod M”.

Further, in the method 2 a register (either X or Y) of the width r with a power of two 2^{k} is initialized with 0≦k<r. This process is expressed by the pseudocode command “SET Z=2^{k}”. The method 2 can then be described as follows:
Method 2
Input values: Exponent e=e₀+e₁·256+ . . . +eₙ·256ⁿ
   module in the register M
Register: M, X, Y
Output value: Power 2^{-e} mod M in register Y
Method course:
   EXECUTE “METHOD 3” (2.0)
      (Generates from exponent e a recoded
      exponent f with f=f₀+f₁·256+ . . . +fₙ·256ⁿ)
   SET Y=2^{fn} (2.1)
   FOR i=n−1 COUNTING DOWN TO 0 (2.2)
      EXECUTE 8 TIMES (2.3)
         SET Y*=Y*R⁻¹ mod M (2.4)
      END (2.5)
      SET X=2^{f}^{ᵢ} (2.6)
      SET Y*=X*R⁻¹ mod M (2.7)
END (2.8)

Except for the preparing step in line (2.0), the structure of the method 2 corresponds exactly to the structure of method 1. After the initialization of the register Y in line (2.1) again a loop is executed with the lines (2.3)-(2.7) as a loop body. In the lines (2.3) and (2.4), here a Montgomery squaring, repeated eight times, of the intermediate result in the register Y is executed, and in the lines (2.6) and (2.7) there is effected a Montgomery multiplication of the register Y with the factor 2^{f}^{ᵢ}. The methods 1 and 2 merely differ in the recoding of the exponent in step (2.0) and in that Montgomery multiplications and Montgomery squarings are employed instead of normal modular multiplications and squarings.

In a modification of the above-described method 2 the two lines (2.6) and (2.7) can be combined into one single command, in which the value of the register Y is replaced by the product Y·2^{f}^{_{i-n′}} mod M; here, n′ is the binary logarithm of the Montgomery parameter R, so that R=2^{n′} applies. In the pseudo notation employed here, this combined command could be expressed with “SET Y*=2^{f}^{ᵢ}*2^{-n′} mod M”.

For some of the coprocessors 56, 56′, 56″, 56′″ that are treated here the result of the method 2 might deviate by a small multiple of the module M from the desired final result 2^{-e} mod M. It may therefore be necessary to execute as a terminating correction step a modular reduction of the register Y modulo M.

In the exemplary embodiment described here, the recoding of the exponent e in line (2.0) is effected according to the following method:
Method 3
Input values: Exponent e=e₀+e₁·256+ . . . +eₙ·256ⁿ
   Logarithm n′ of the Montgomery parameter R to the base 2 (therefore R=2^{n′} applies)
Output value: Recoded exponent f with f=f₀+f₁·256+ . . . +fₙ·256ⁿ for employment in method 2
Method course:
   SET f=n′·(256+256²+256³+ . . . +256ⁿ)−e (3.1)
   STORE f₀, f₁, . . . fₙ (3.2)
      WITH f=f₀+f₁·256+ . . . +fₙ·256ⁿ (3.3)
      AND 0≦fᵢ<256 FOR 0≦i<n (3.4)

With the following argumentation it can be illustrated that the method 2 with the recoding of the exponent e according to method 3 yields the correct result: First it is to be noted that during the method course all the values in the registers X and Y are always modular powers of two (with module M), because the registers with powers of two are initialized, and because the Montgomery operations can be written as modular multiplications with (where applicable, negative) powers of two as factors. The executed calculations can thus be written more clearly in the form of their logarithms to the base 2 with regard to the module M.

For Y=2^{y} and R=2^{n′} the Montgomery squaring in line (2.4) can be written as a duplication and subtraction, in which y is replaced by 2·y·n′ (operation “S”). The combined operation from the lines (2.7) and (2.8), which can be written on the register level as “SET Y*=2^{k}*2^{-n′} mod M”, in the logarithmic representation replaces y by y+k−n′ (operation “Mₖ”).

In method 2, the operation S is respectively executed eight times and then the combined operation Mₖ once. In the logarithmic notation this method course can be represented as follows:

y→s2·y−n′→s4·y−3·n′→s8·y−7·n′→s . . .

. . . →s256·y−255·n′→Mₖ256·(y−n′)+k

To represent a suitable recoding of the exponent e, the bytes fₙ, fₙ₋₁, f₀ of the recoded exponent f must have the property that the sequence defined in the following yₙ, yₙ₋₁, . . . , y₀ yields the result y₀=−e; the composition of functions is expressed by the symbol “∘”:

yₙ:=fₙ

yᵢ:=M_{fi}·S⁸(yᵢ₊₁)=256·(yᵢ₊₁−n′)+fᵢ for i=n−1, . . . ,0

By induction over n there can be shown that the recoding defined in method 3 has the just-mentioned property and thus leads to a correct result of the method 2.

FIG. 5 illustrates an exemplary course of the just-described methods 2 and 3. In step 80 the recoding of the exponent e is effected according to method 3, in order to obtain from the original exponent e with its bit groups 82—here the bytes eₙ, eₙ₋₁, e₀—the recoded exponent f with its bit groups 84—here the bytes fₙ, fₙ₋₁, . . . , f₀.

The method course following after the recoding in step 80 can be divided in an initialization 86 and n segments 88. In the course of the initialization 86, in step 90 the command “SET Y=2^{fn″} according to line (2.1) of the method 2 is executed. Each of the n segments 88 respectively corresponds to a loop iteration of the method 2 and is associated with respectively one of the bit groups 84 of the recoded exponent f.

Each segment 88 has three essential steps 92, 94 and 96. In step 92, according to the lines (2.3) and (2.4) of method 2 there are executed eight Montgomery squarings of the intermediate result contained in the register Y. In step 94, which corresponds to the line (2.6), in the register X there is stored a power of two with an exponent which is formed by the associated bit group 84 of the recoded exponent f. This step 94 can be efficiently implemented by the register X first being deleted and then the one bit, whose bit position is stated by the associated bit group 84, being set to the value “1”. Step 96 corresponds to line (2.7) of method 2 and includes a Montgomery multiplication of the registers Y and X.

After altogether n segments 88 having been executed, there is present—after a correction, which might still be required, through a modular reduction in step 98—the desired final result 2^{-e} mod M in register Y.

In the following, some optional refinements and developments of the hitherto described methods 2 and 3 are represented. In different alternative embodiments, different combinations of these refinements and developments can be used in order to for example adapt the methods used particularly well to certain Montgomery coprocessors 56, 56′, 56″, 56′″ or in order to further increase the security against spying.

First, the potential difficulty in the exponent recoding according to method 3 that for fₙ a value greater than 255 can occur is dealt with. For a small eₙ then, possibly, the value 2^{fn} determined in step (2.1) by method 2 is greater than the module m and thus too great for being stored as an initial value in the register Y. However, in all the Montgomery coprocessors 56, 56′, 56″, 56′″ treated herein, the register size for the module m can be selected such that for the respective Montgomery coefficient n′ the inequation 2^{(4/5)·n′}<m<2^{n′} is fulfilled. The condition 2^{fn}<m can then be strengthened for a very small

ε>0 as follows:

fₙ=n′·(256/255)·(1−ε)−eₙε[0,(4/5)·n′]

The just-mentioned condition is in any case fulfilled when the inequation ¼·n′<eₙ<n′, which is referred to in the following with (*), applies.

If method 3 results in a too great value for fₙ, this value can be modularly reduced before step 90 of FIG. 5 with the module m, so that then in step 90 the register Y is set to the resulting remainder. For very small eₙ (eₙ<n′/256) it is also possible to take up the n-th segment 82 into the (n−1)-th segment 82. In this case n is reduced by 1, and eₙ₋₁ is increased by eₙ·256. Further, in some configurations it can be provided to set the value of the exponent e such that fₙ remains sufficiently small.

Summing up, the calculation of the correction factor C in step 74.2 (FIG. 4) can thus be effected by the following method B:

Method B
Input values: d-bit-wide value (e.g. prime number p′) in the register X
n·d-bit-wide value (e.g. base b) in the register Y
Register: B, C, X, Y, Z
Output value: Remainder Y mod X in register Z
Method course:
   SET B=Y*2^{-d·n} mod X (B.1)
   SET C=(½)^{k·φ(X)-d·(n+1)} mod X
      EMPLOYING THE METHODS 2 AND 3
      FOR A SUITABLY SELECTED k (B.2)
   SET Z=B*C*2^{-d} mod X (B.3)

The lines (B.1) and (B.3) correspond to the lines (A.1) and (A.3) of the method A and include respectively one Montgomery multiplication. In line (B.2) the above-described methods 2 and 3 are executed for the modular calculation of the power of base ½. In so doing, the value k is selected such that the exponent k·φ(X)−d·(n+1) is positive and that the inequation (*) is fulfilled. In many embodiments, the module X and the exponents respectively have a length of no more than 16 bits, so that for the calculation of the correction factor in line (B.2) 16 Montgomery squarings and 4 Montgomery multiplications are sufficient.

A further optimized modification of the just-represented method B is described in the following, which is particularly suitably for the execution by the coprocessor 56′″. In case of data carriers 50 having a coprocessor 56″, the method can be executed with minor modifications by the main processor 54.

The method described in the following is both optimized with respect to its execution speed and also with respect to its security against spying. In view of the security against spying there exists a potential possibility of attack due to the fact that the remainder to the base value b of the sieve is calculated modulo many small prime numbers. An attacker theoretically could ascertain the current flow curve—or other side channel information—of these modular reductions and evaluate it for a side channel attack in which the highest or lowest word of the base value b is guessed and then data about the beginning of each reduction are spied out.

To ward off such attacks, in some exemplary embodiments—as e.g. in the following method—it is provided to carry out the Montgomery reductions not modulo respectively one prime number, but modulo respectively one pair of prime numbers. As a positive side effect, this also accelerates the sieve process, because only half as many time-consuming long reductions need to be carried out. In further modifications there can also be employed tuples with more than two prime numbers.

For the following method p₀ and p₁ be respectively a small prime number, and m=p₀·p₁ be the product of this prime number pair. First, the Montgomery reduction of the base value b is executed modulo this prime number product m, as this corresponds to step 74.1 in FIG. 4 or line (A.1) in method A. By a Montgomery multiplication there is thus calculated a value r with the following property:

r=b*ₘ1=b·R⁻¹ mod m

The Montgomery coefficient R is here 2^{128·t}, the smallest possible register size 128·t being selected which is sufficient to take up the base value b. In the present case it is assumed that the registers, in which the factors b and 1 of the Montgomery reduction are stored, respectively are 128 bit long.

For each of the two prime numbers p₀ and p₁ the following steps (method C) are now executed in order to obtain the remainder b mod p′ from the intermediate result r. Upon the first execution of the method C there is thus set p′=p₀, and upon the second execution of the method p′=p₁. The method C thus corresponds to the steps 74.2 and 74.3 in FIG. 4 or the lines (A.2) and (A.3) of the method A:

Method C
Input values: d-bit-wide composite value m
   prime number p′ with p′<2¹⁴, which divides m
   value r=b·2^{-d·n} mod m as stated above
Register: A, B, F, R, X, Y
Output value: Remainder b mod p′ in register R
Method course:
   SET X=p′−1 (C.1)
   DUPLICATE X, UNTIL X≧(1<<15) (C.2)
   SET Y=((1<<16)−X)+((n+1)<<8) (C.3)
   WHEN Y≧(1>>15) THEN (C.4)
      SET Y=Y−(X>>1) (C.5)
   SET F=Y>>1 (C.6)
   SET A=1<<(F>>7) (C.7)
   SET B=1 (C.8)
   SET R=A*B*2⁻¹²⁸ mod p′ (C.9)
   EXECUTE 7 TIMES (C.10)
      SET R=R*R*2⁻¹²⁸ mod p′ (C.11)
   END (C.12)
   SET A=F mod (1<<7) (C.13)
   SET R=A*R*2⁻¹²⁸ mod p′ (C.14)
   SET A=r (C.15)
   SET R=A*R*2⁻¹²⁸ mod p′ (C.16)

In the above-described method X>>n represents the bitwise shift of the register or of the constant X by n bit positions to the right, and X<<n represents the corresponding shift to the left.

In the lines (C.1)-(C.6) there is calculated a suitable correction-factor exponent f in the register F, which exponent has a form as in line (B.2), but is additionally recoded as in method 3. In so doing, first, in the lines (C.1) and (C.2) the 16-bit-integer in the register X is duplicated until it is negative. Then in line (C.3) a value between 2 and 33 is added to the higher-order byte of −X, X being the value contained in the register X. In the lines (C.4) and (C.5) the intermediate result is corrected, when it is too great. Finally, in line (C.6) the correction-factor exponent f in register F is calculated by halving the intermediate result in the register Y.

In the lines (C.7)-(C.14) the correction factor in the register R is calculated with steps similar to that in method 2. Because of the precondition p′<2¹⁴, the maximum required two loop iterations of the method 2 are “unrolled” here. More precisely, the lines (C.7)-(C.9) correspond to a first Montgomery multiplication as in line (2.7) of method 2, the lines (C.10)-(C.12) correspond to a Montgomery squaring repeated 7 times, and the lines (C.13) and (C.14) correspond to a second Montgomery multiplication as in line (2.7) of method 2. When in an alternative embodiment greater prime numbers p′ may occur, the method C can be suitably modified by including a corresponding number of further loop iterations of the method 2. For example, there can be provided that further 7 Montgomery squarings and one further Montgomery multiplication are executed.

In the lines (C.15) and (C.16) there is finally applied the correction factor, which is contained in register R after the execution of the line (C.4), to the result r of the Montgomery reduction. Altogether, the lines (C.1)-(C.15) of method C thus correspond to the partial step 74.2 in FIG. 4, while the lines (C.15) and (C.16) correspond to the partial step 74.3.

It is to be understood, that the configurations of an efficient remainder calculation and determination of prime number candidates, as they are described herein, are not restricted to the method course according to FIG. 1 and FIG. 2, but that in alternative embodiments they can also be provided for other application purposes, in particular in the field of cryptography for the execution by one or several processors. It is further to be understood, that the embodiments and embodiment variants are to be seen merely as examples. Further modifications and combinations of the features described herein are immediately obvious to the person skilled in the art.

1-20. (canceled)

21. A method for determining the division remainder of a first value (b) modulo a second value (p′) for a cryptographic application, wherein the method is executed by at least one processor and includes:
executing a Montgomery multiplication with the first value (b) as one of the factors and the second value (p′) as a module,
determining a correction factor, wherein in a correcting Montgomery multiplication the correction factor is employed as a factor, in order to obtain the division remainder of the first value (b) modulo the second value (p′).

22. The method according to claim 21 wherein executing the Montgomery multiplication with the first value (b) as one of the factors and the second value (p′) as a module is a first Montgomery multiplication and by
executing a second Montgomery multiplication, as the correcting Montgomery multiplication, with the result of the first Montgomery multiplication as one of the factors and the correction factor as the other factor and the second value (p′) as a module, in order to obtain the division remainder of the first value (b) modulo the second value (p′).

23. The method according to claim 21, wherein the first Montgomery multiplication is a Montgomery reduction.

24. The method according to claim 22, wherein the correction factor is determined for the second Montgomery multiplication after the first Montgomery multiplication.

25. The method according to claim 22, wherein the correction factor serves for compensating the error caused by the first and the second Montgomery multiplication.

26. The method according to claim 22, wherein the first and the second Montgomery multiplication are executed with different Montgomery coefficients.

27. The method according to claim 21 wherein the executed Montgomery multiplication with the first value (b) as one of the factors and the second value (p′) as a module is the correcting Montgomery multiplication which employs the correction factor as the other factor.

28. The method according to claim 27 wherein if the second value (p′) is a product of prime numbers.

29. The method according to claim 21, wherein the correction factor is calculated as a modular power of two in several loop iterations, wherein each loop iteration has a duplication of an intermediate result and a conditional subtraction.

30. The method according to claim 21, wherein the correction factor is calculated as a modular power with a positive and integer correction-factor exponent and the base ½.

31. The method according to claim 30, wherein the calculation of the correction factor has a series of several Montgomery squarings of an intermediate result, after which a Montgomery multiplication of the intermediate result with a factor dependent on the correction-factor exponent is executed.

32. A method for ascertaining prime number candidates which represent with a certain probability prime numbers, for a cryptographic application, wherein the method is executed by at least one processor and includes:
determining a base value (b) for a sieve, and
executing several sieve iterations, in which respectively one marking value (p′;r, r′) is ascertained and multiples of the marking value (p′; r, r′) in the sieve are marked as composite numbers, wherein upon each sieve iteration a division remainder of the base value (b) modulo the marking value (p′; r, r′) is determined with a remainder determination method which comprises at least one Montgomery operation.

33. The method according to claim 32, wherein the marking value (p′; r, r′) is a prime number.

34. The method according to claim 32, wherein the sieve is represented by a bitfield (S), whose bits (S[i]) correspond to values which, starting out from the base value (b), have a predetermined step width which is greater than or equal to or greater than 2.

35. The method according to claim 32, wherein each ascertained prime number candidate is subjected to at least one probabilistic prime number test.

36. The method according to claim 32, wherein a method employed as the remainder determination includes determining the division remainder of a first value (b) modulo a second value (p′) for a cryptographic application, and is executed by at least one processor and includes:
executing a Montgomery multiplication with the first value (b) as one of the factors and the second value (p′) as a module,
determining a correction factor, wherein in a correcting Montgomery multiplication the correction factor is employed as a factor, in order to obtain the division remainder of the first value (b) modulo the second value (p′).

37. The method according to claim 36, wherein in one of the sieve iterations:
the first Montgomery operation is executed for a product (p′) of marking values (r, r′),
the second Montgomery operation is executed respectively for the marking values (r, r′) and
respectively the multiples of the marking values (r, r′) are marked.

38. The method according to claim 21, wherein the method serves for the determination of at least one parameter of an RSA key or an RSA-CRT key.

39. A computer program product having a plurality of program commands which prompt at least one processor of a portable data carrier, to execute a method according to claim 21.

40. A portable data carrier having at least one processor and at least one memory, wherein the device is arranged to execute a method according to claim 21.
